(19) United States
(12) Patent Application Publication
(10) Pub. No.: US 2026/0027832 A1
(43) Pub. Date: Jan. 29, 2026

(54) INK CARTRIDGE AND INK EJECTION APPARATUS

(71) Applicant: CANON KABUSHIKI KAISHA, Tokyo (JP)

(72) Inventor: KATSUNORI OYA, Kanagawa (JP)

(21) Appl. No.: 19/275,422

(22) Filed: Jul. 21, 2025

(30) Foreign Application Priority Data
Jul. 26, 2024 (JP) 2024-121287

(51) Int. Cl. B41J 2/175

(52) U.S. Cl. CPC B41J 2/17513; B41J 2/17553

(57) ABSTRACT

An ink cartridge includes: an absorber that is capable of absorbing ink; and a container that contains therein the absorber and the ink. The container is provided with an opening port that opens an interior of the container to an atmosphere. The absorber is provided with a space capable of storing the ink. The space does not contact a bottom surface inside the container in a state in which the absorber is contained in the container.

### BACKGROUND

### Field of the Technology

The present disclosure relates to an ink cartridge containing ink and an ink ejection apparatus that ejects ink supplied from the ink cartridge.

### Description of the Related Art

An ink-jet recording apparatus is installed with an ink cartridge containing ink, supplies the ink from the ink cartridge to a recording head, and discharges the ink from the recording head onto a recording medium such as paper to perform recording on the recording medium. The ink cartridge is a liquid storage container that contains ink to be supplied to the recording head, and is attachable to and detachable from the recording apparatus. Some ink cartridges contain an absorber that absorbs ink in order to ensure favorable ink supply from the ink cartridge to the recording head. The absorber is made of a porous material and absorbs and retains ink by a capillary force. In the thus configured ink cartridge, it is required that ink can be supplied stably while increasing the ink retention content per unit volume.

Japanese Patent Application Publication No. 2015-199276 discloses an ink cartridge in which an absorber is provided with a recessed portion at a position in contact with the bottom surface of a container of the ink cartridge, and the recessed portion forms a space for storing ink between the bottom surface of the container and an end portion of the absorber. The density of the ink in this space is higher than the density of the ink absorbed by the absorber. Accordingly, the ink retention content of the ink cartridge can be increased by changing the size of the recessed portion by changing the shape of the absorber, without changing the volume of the container.

The ink cartridge may take various postures during transport in logistics or use by a consumer. For example, the ink cartridge takes various postures, since some consumers store an ink cartridge in a new package upside down or in a horizontal orientation. Besides taking various postures, the ink cartridge may be subjected to an impact, such as when an ink cartridge in a new package or taken out of a package falls from the hand. The ink stored in the space between the absorber and the bottom surface of the container has higher fluidity than the ink absorbed by the absorber. In the ink cartridge disclosed in Japanese Patent Application Publication No. 2015-199276, this space is in contact with the bottom surface of the container. In other words, a part of the inner wall surface for this space is formed by the surface of the absorber, and another part is formed by the bottom surface of the container. Since the bottom surface of the container has a small resistance to ink flow, the ink in the space flows vigorously when the posture of the ink cartridge is changed or an impact is applied thereto, and the ink may splash out of the absorber. Since the container of the ink cartridge has an atmosphere opening port through which air can be introduced into the container, ink that has splashed out of the absorber may leak out of the ink cartridge through the atmosphere opening port.

### SUMMARY

The present disclosure is directed to provide an ink cartridge having an absorber that absorbs ink and a space for storing the ink in a container, wherein leakage of the ink from an atmosphere opening port is suppressed even when the posture is changed or an impact is applied.

The present disclosure provides an ink cartridge including:
an absorber that is capable of absorbing ink; and
a container that contains therein the absorber and the ink, the container being provided with an opening port that opens an interior of the container to an atmosphere,
wherein the absorber is provided with a space capable of storing the ink, and
wherein the space does not contact a bottom surface inside the container in a state in which the absorber is contained in the container.

Features of the present disclosure will become apparent from the following description of embodiments with reference to the attached drawings. The following description of embodiments are described by way of example.

### BRIEF DESCRIPTION OF THE DRAWINGS

FIG. 1A is a perspective view of an ink cartridge according to a first embodiment;

FIG. 1B is a view of FIG. 1A viewed in the Z direction from below;

FIG. 2 is an exploded view of the ink cartridge according to the first embodiment;

FIG. 3A is a top view of the ink cartridge according to the first embodiment;

FIG. 3B is a sectional view taken along line A-A in FIG. 3A;

FIG. 4 is an exploded view of an absorber of an ink cartridge according to a second embodiment;

FIG. 5A is a top view of the ink cartridge according to the second embodiment;

FIG. 5B is a sectional view taken along line A-A in FIG. 5A;

FIG. 6 is an exploded view of an absorber of an ink cartridge according to a third embodiment;

FIG. 7A is a top view of the ink cartridge according to the third embodiment;

FIG. 7B is a sectional view taken along line A-A in FIG. 7A;

FIG. 8A is a sectional view of an ink cartridge according to a fourth embodiment;

FIG. 8B is a bottom view of the ink cartridge according to the fourth embodiment;

FIG. 9A is a perspective view of an absorber of an ink cartridge according to a fifth embodiment;

FIG. 9B is an exploded view of the absorber of the ink cartridge according to the fifth embodiment; and

FIG. 10 is a perspective view of a recording apparatus in which an ink cartridge according to an embodiment is mounted.

### DESCRIPTION OF THE EMBODIMENTS

Hereinafter, exemplary embodiments for carrying out the present disclosure will be described with reference to the drawings. However, the dimensions, materials, shapes, relative arrangement, and the like of the components described in the following embodiments should be changed as appropriate depending on the configuration and various conditions of the device to which the present disclosure is applied, and are not intended to limit the scope of the present disclosure to the following embodiments.

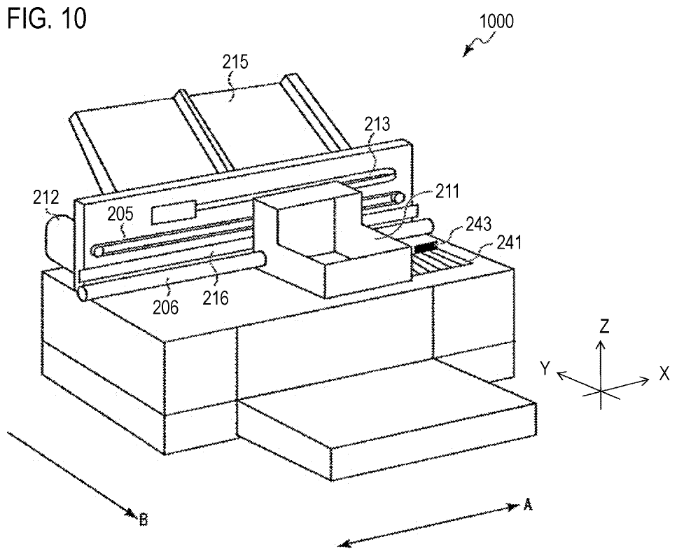

FIG. 10 is a perspective view illustrating an ink-jet recording apparatus 1000 in which an ink cartridge according to an embodiment of the present disclosure is mounted. The recording apparatus 1000 illustrated in FIG. 10 includes a carriage (mounting portion) 211 inside which an ink cartridge 1 is mountable. In the recording apparatus 1000, the carriage 211 is guided along a guide shaft 206 so as to be movable in the main scanning direction indicated by arrow A. The guide shaft 206 is disposed so as to extend along the width direction of a recording medium. Accordingly, the ink cartridge 1 mounted on the carriage 211 performs recording while scanning in a direction intersecting a conveyance direction in which the recording medium is conveyed. Thus, the recording apparatus 1000 is a so-called serial scan type recording apparatus that records an image with the movement of the ink cartridge 1 in the main scanning direction and the conveyance of the recording medium in the sub-scanning direction. The ink cartridge according to the present disclosure is not limited to one for use in a serial scan type recording apparatus, and is also applicable to an ink cartridge for use in a full line type recording apparatus that uses a recording head extending over the entire recording medium in the width direction, for example.

The carriage 211 is penetrated and supported by the guide shaft 206 so as to scan in a direction orthogonal to the conveyance direction of the recording medium. A belt 205 is attached to the carriage 211, and a carriage motor 212 is attached to the belt 205. Thus, the driving force of the carriage motor 212 is transmitted to the carriage 211 via the belt 205, so that the carriage 211 is movable in the main scanning direction while being guided by the guide shaft 206.

A flexible cable 213 for transferring an electrical signal from a control portion to the ink cartridge 1 is attached to the carriage 211 so as to be electrically connected to the ink cartridge 1. Further, the recording apparatus 1000 includes a cap 241 and a wiper blade 243 which are used to perform a recovery process of the ink cartridge 1. The recording apparatus 1000 also includes a sheet feeding portion 215 that stores recording media in a stacked state, and an encoder sensor 216 that optically reads the position of the carriage 211.

The carriage 211 is moved back and forth in the main scanning direction by a carriage motor and a drive force transmission mechanism such as a belt that transmits the drive force of the carriage motor. After the recording medium is loaded on the sheet feeding portion 215, the recording medium is conveyed in the sub-scanning direction indicated by arrow B by a conveyance roller. The recording apparatus 1000 is an ink ejection apparatus that sequentially records images on a recording medium by repeating a recording operation of ejecting ink while moving an ink-jet head in the main scanning direction and a conveyance operation of conveying the recording medium in the sub-scanning direction.

In the following description, a direction parallel to the main scanning direction is an X direction, a direction parallel to the sub-scanning direction is a Y direction, and a direction perpendicular to the X and Y directions is a Z direction. The Z direction is a direction parallel to the vertical direction when the recording apparatus 1000 is installed on the horizontal plane. In the following description, the relationship between the ink cartridge 1 and the X, Y, and Z directions is based on the posture of the ink cartridge 1 mounted to the carriage 211. However, the ink cartridge 1 is attachable to and detachable from the carriage 211 of the recording apparatus 1000, and the ink cartridge 1 alone, which has been removed from the carriage 211, can take a free posture.

### First Embodiment

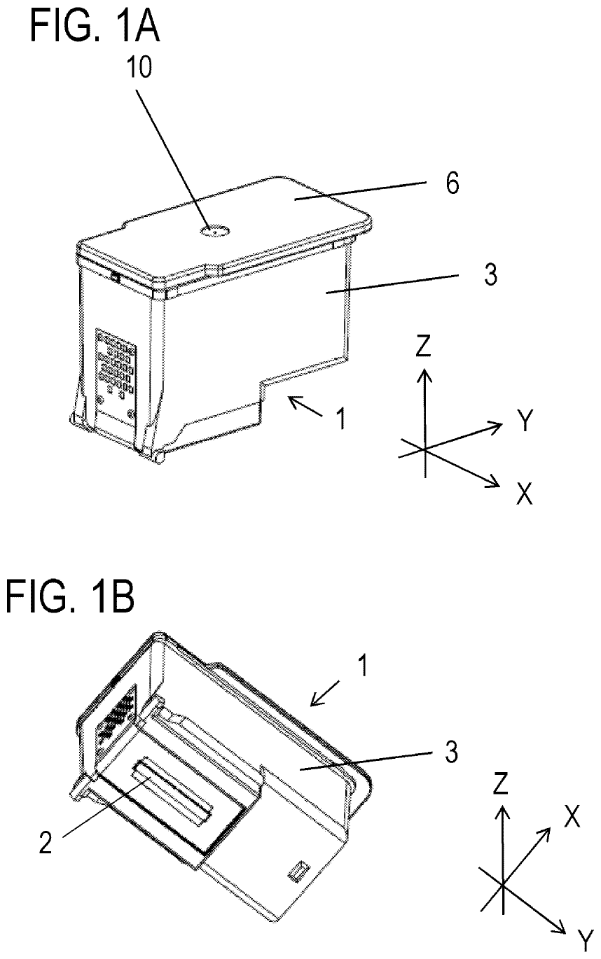

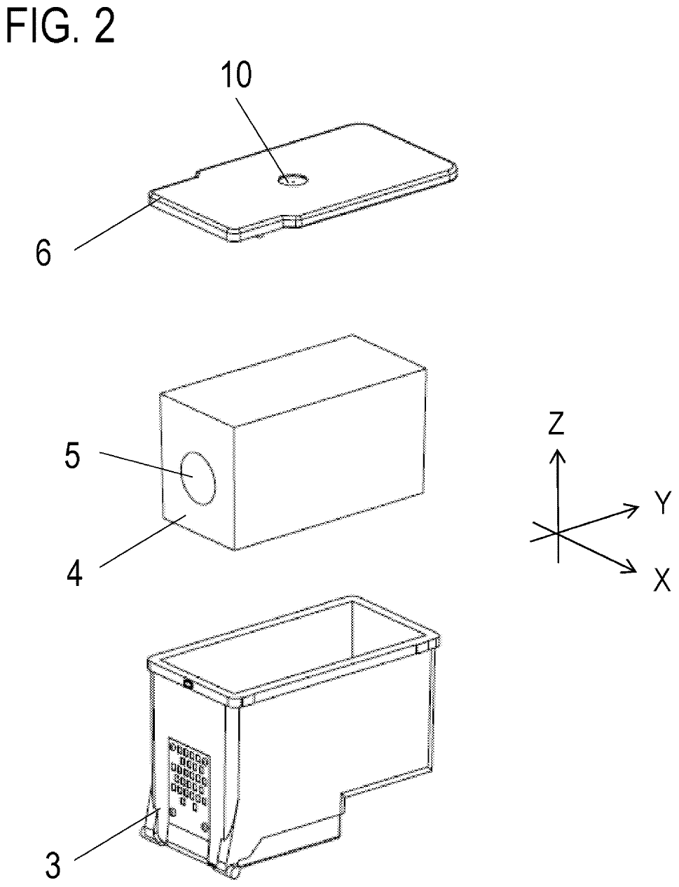

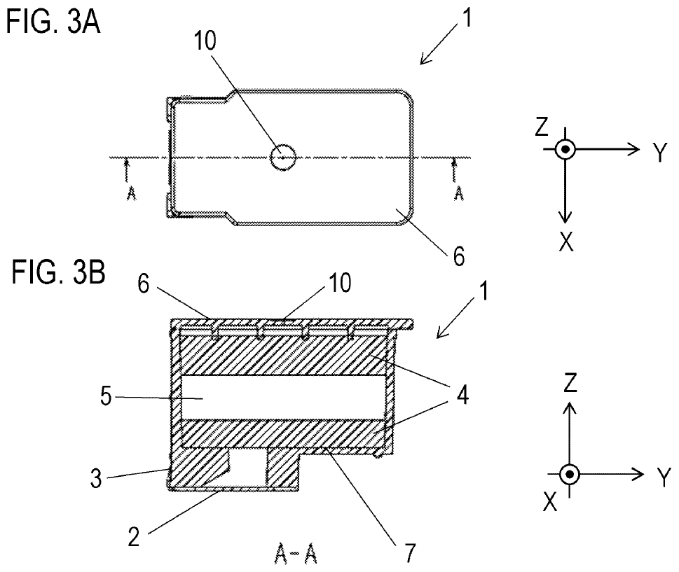

FIGS. 1A and 1B illustrate the appearance of an ink cartridge 1 according to a first embodiment of the present disclosure. FIG. 1A is a perspective view of the ink cartridge 1, and FIG. 1B is a view of FIG. 1A viewed in the Z direction from below. FIG. 2 is an exploded view of the ink cartridge 1 according to the first embodiment. FIG. 3A is a top view of the ink cartridge 1 according to the first embodiment, and FIG. 3B is a sectional view taken along line A-A in FIG. 3A.

As illustrated in FIGS. 1A, 1B, and 2, the ink cartridge 1 includes a recording head 2, a container 3, an absorber 4, and a lid member 6. The recording head 2 can be supplied with ink contained in the container 3 and eject the ink, and is fixed to the bottom portion of the container 3 with an adhesive with high air tightness. The container 3 can contain the absorber 4, and has an open top. The lid member 6 is joined to the top of the container 3 to seal the opening at the top of the container 3 to protect the interior of the container 3. The lid member 6 is provided with an atmosphere opening port 10 that opens the inside of the container 3 to the atmosphere. Air is introduced from the atmosphere opening port 10 as the ink in the container 3 is consumed.

The absorber 4 is capable of absorbing ink and is pushed to be inserted into the container 3. In a state in which the absorber 4 is contained in the container 3, a lower end portion of the absorber 4 is in close contact with an inner bottom surface 7 of the container 3. The absorber 4 is formed of a porous body such as urethane foam. It should be noted that the absorber 4 may be made of other materials, for example, thermoplastic, as long as the absorber 4 can absorb the ink stored in the container 3.

The absorber 4 is provided with a space 5 capable of storing ink. The space 5 is formed so as to penetrate the absorber 4, which is in a substantially rectangular parallelepiped shape, in the Y direction. In a state in which the absorber 4 is contained in the container 3, the space 5 does not contact the inner bottom surface 7 of the container 3. That is, the space 5 is provided above the lower end portion of the absorber 4 in the Z direction. While the space 5 is a cylindrical space extending in parallel to the Y direction in the first embodiment, the shape of the space 5 is an example, and the present disclosure is not limited to this example as long as the space 5 does not contact the inner bottom surface 7 in a state in which the absorber 4 is contained in the container 3. For example, the space 5 may be shaped to penetrate in a first direction along the inner bottom surface 7 of the container 3. The first direction may be a direction parallel to the Y direction (the X and Z components of the direction vector are 0) as in the first embodiment, may be a direction parallel to the X direction, or may be a direction intersecting the X and Y directions. Further, the first direction may be a direction, the Z component of the direction vector of which is not 0, as long as the space 5 does not contact the inner bottom surface 7. Further, while one space 5 is formed in the absorber 4 in the illustrated example, a plurality of spaces 5 may be provided.

The recording head 2 can be supplied with ink by filling the absorber 4 and the space 5 with the ink.

The ink in the space 5 has a higher ink density than the ink in the absorber 4. Therefore, the ink amount per volume in the ink cartridge 1 can be increased by providing the space 5 in the absorber 4. The ink in the space 5 has higher fluidity than the ink in the absorber 4. Therefore, the ink in the space 5 flows in response to a change in the posture of the ink cartridge 1 during transport or an impact due to a fall or the like.

In the ink cartridge 1 according to the first embodiment, the ink in the space 5 provided in the absorber 4 is not in contact with the inner bottom surface 7 of the container 3. Therefore, the resistance to the flow of ink in the space 5 is great. Accordingly, the impetus of the flow of the ink in the space 5 is suppressed at the time of a change in the posture of the ink cartridge or an impact due to a fall or the like. Thus, it is possible to suppress ink splashing out of the absorber 4 and flowing toward the lid member 6 at the time of a change in the posture of the ink cartridge or an impact due to a fall or the like, and to suppress the ink leaking to the outside through the atmosphere opening port 10.

### Second Embodiment

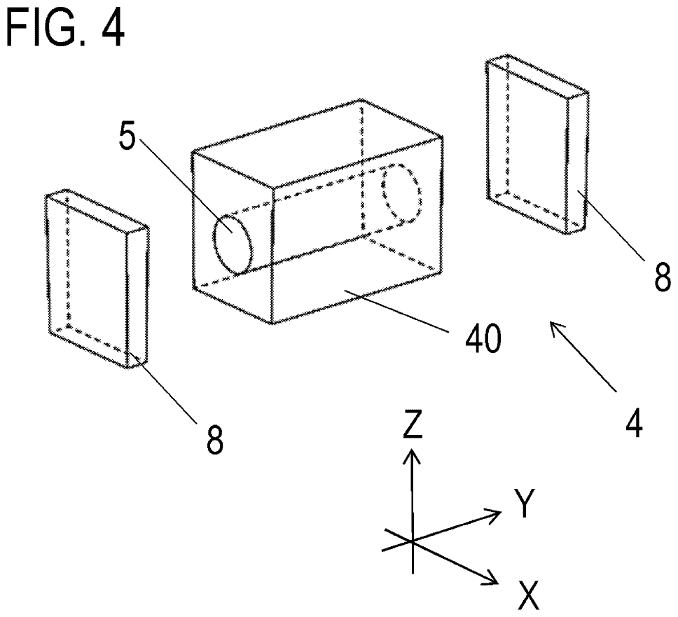

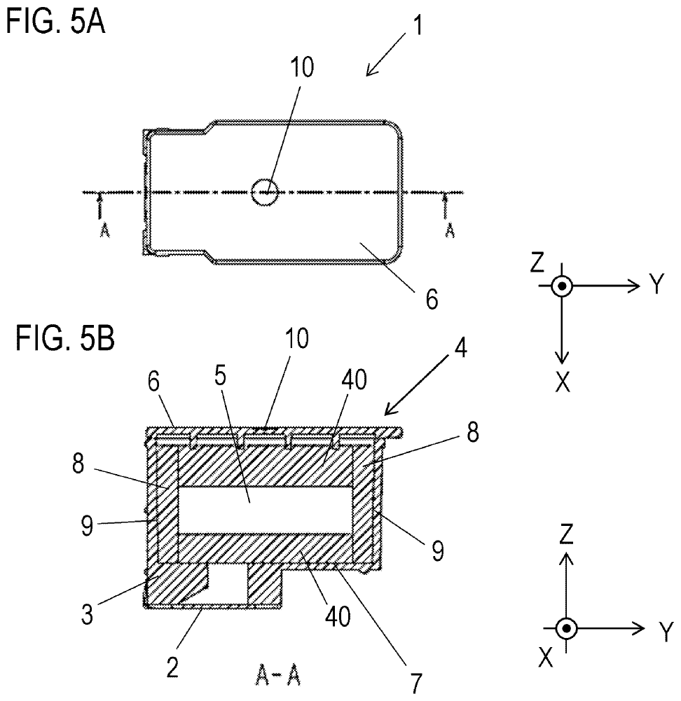

FIG. 4 is an exploded view of an absorber 4 of an ink cartridge 1 according to a second embodiment of the present disclosure. FIG. 5A is a top view of the ink cartridge 1 according to the second embodiment, and FIG. 5B is a sectional view taken along line A-A in FIG. 5A. The second embodiment is different from the first embodiment in that the absorber 4 according to the second embodiment includes a body portion 40 and side surface portions 8, and the absorber 4 is contained in a container 3 by inserting the body portion 40 and the side surface portions 8 together into the container 3. The side surface portions 8 are disposed at both end portions of the body portion 40 in the Y direction in the container 3. The body portion 40 and the side surface portions 8 have substantially the same cross-sectional shape perpendicular to the Y direction. The shapes of the body portion 40 and the side surface portions 8 are examples, and the shapes of the body portion 40 and the side surface portions 8 are appropriately set in accordance with the internal shape of the container 3. The shape of the body portion 40 is the same as that of the absorber 4 according to the first embodiment except that the size of the absorber 4 according to the first embodiment in the Y direction is smaller for the two side surface portions 8. That is, the body portion 40 is provided with a cylindrical space 5 that penetrates in the Y direction. The space 5 is a closed space in a state in which the absorber 4 (body portion 40 and two side surface portions 8) is contained in the container 3.

Thus, as illustrated in FIG. 5B, the space 5 is not in contact with an inner bottom surface 7 of the container 3 and is not in contact with inner side surfaces 9. With this structure, the resistance to the flow of ink in the space 5 is greater than that in the first embodiment. Accordingly, it is possible to more reliably suppress the ink leaking to the outside through the atmosphere opening port 10.

### Third Embodiment

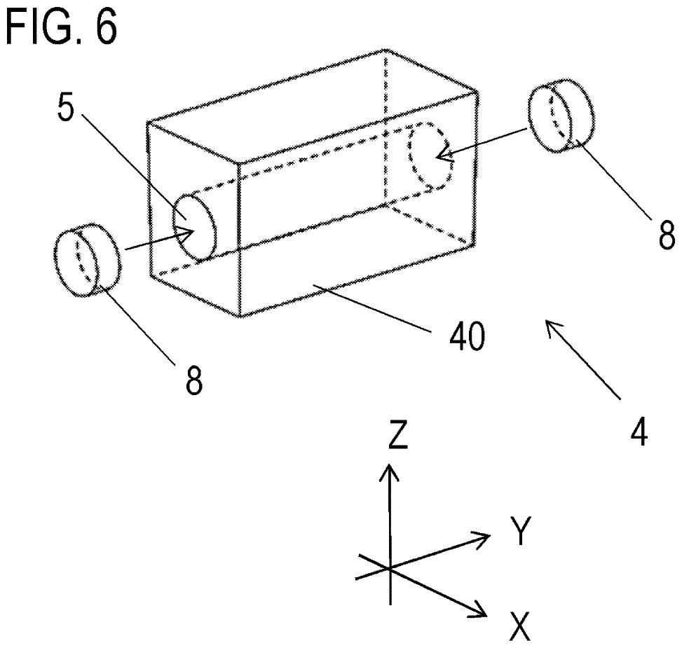

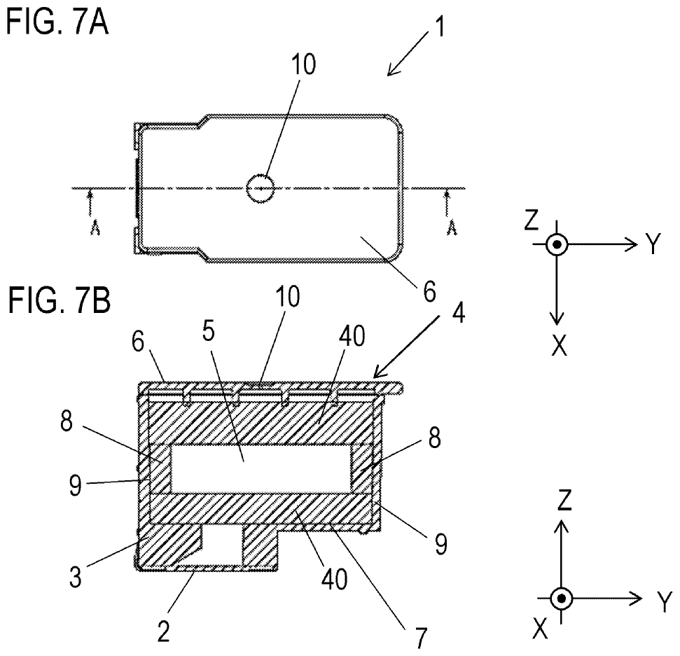

FIG. 6 is an exploded view of an absorber 4 of an ink cartridge 1 according to a third embodiment of the present disclosure. FIG. 7A is a top view of the ink cartridge 1 according to the third embodiment, and FIG. 7B is a sectional view taken along line A-A in FIG. 7A. The third embodiment is different from the second embodiment in that a space 5 of a body portion 40 and side surface portions 8 have substantially the same cross-sectional shape perpendicular to the Y direction in the third embodiment. In other words, the space 5 can be formed into a substantially closed space by inserting the side surface portions 8 into both end portions of the space 5 in the Y direction. After the side surface portions 8 are inserted into the space 5 of the body portion 40, the absorber 4 which is composed of the body portion 40 and the side surface portions 8 is inserted into a container 3.

As illustrated in FIG. 7B, the space 5 is not in contact with an inner bottom surface 7 of the container 3 and is not in contact with inner side surfaces 9. With this structure, the resistance to the flow of ink in the space 5 is greater than that in the first embodiment. Accordingly, it is possible to more reliably suppress the ink leaking to the outside through the atmosphere opening port 10. Further, since the body portion 40 and the side surface portions 8 can be integrated by inserting the side surface portions 8 into the space 5 of the body portion 40, the workability of inserting the absorber 4 into the container 3 is better than that in the second embodiment.

### Fourth Embodiment

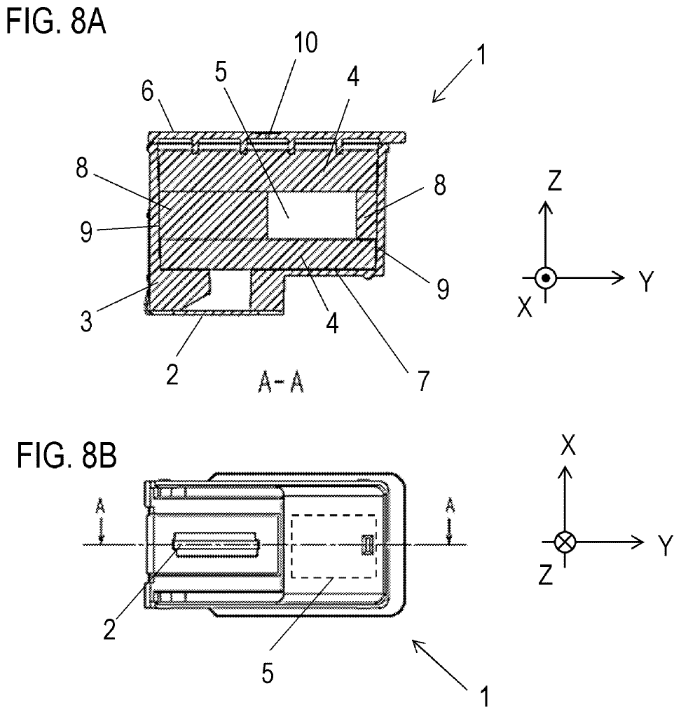

FIG. 8A is a sectional view of an ink cartridge 1 according to a fourth embodiment of the present disclosure, and is a sectional view taken along line A-A in FIG. 8B. FIG. 8B is a bottom view of the ink cartridge 1 according to the fourth embodiment. The fourth embodiment is different from the third embodiment in that one of side surface portions 8 inserted into a space 5 of a body portion 40 is different in size from the other. Specifically, the size in the Y direction of the side surface portion 8 located above a recording head 2 is set such that the space 5 is located at a position not overlapped with the area in which the recording head 2 is provided when viewed in the Z direction. With this structure, it is possible to reduce the freely flowing ink vigorously splashing out toward a lid member 6 from an absorber 4, even without increasing the volume of the space 5 more than necessary. In addition, air bubbles due to the collision between the ink liquid surface and the splashed ink do not occur in the flow path, stabilizing ink-jet ejection.

### Fifth Embodiment

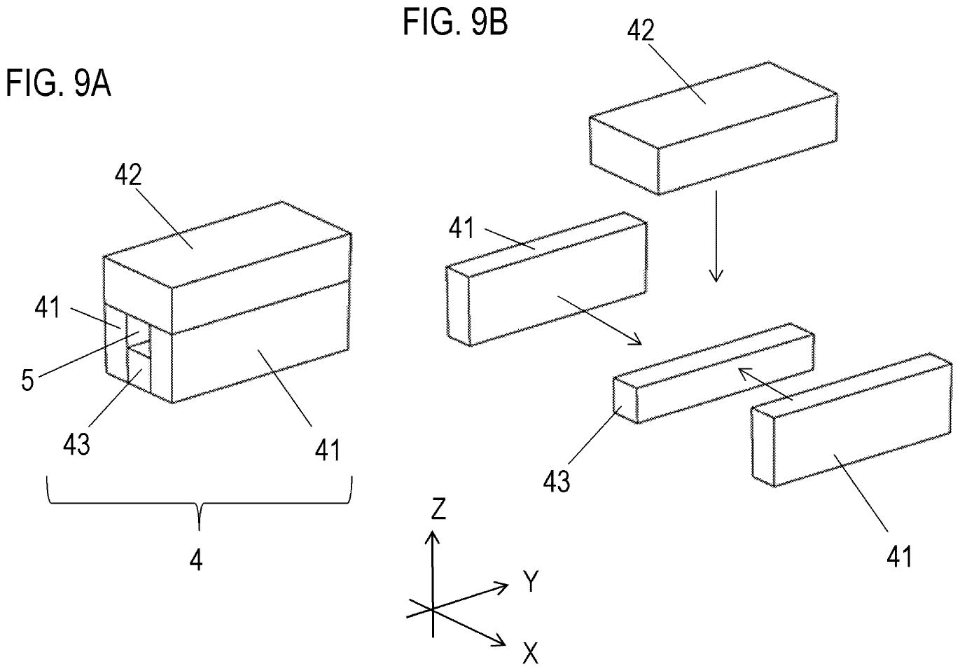

FIG. 9A is a perspective view of an absorber 4 of an ink cartridge 1 according to a fifth embodiment of the present disclosure. FIG. 9B is an exploded view of the absorber 4 of the ink cartridge 1 according to the fifth embodiment. The absorber 4 according to the fifth embodiment includes two wall members 41, an upper member 42, and a lower member 43, and a space 5 is formed inside the absorber 4 when the absorber 4 is assembled using these members. All of the wall members 41, the upper member 42, and the lower member 43 have a rectangular parallelepiped shape (quadrangular prism shape) extending in the Y direction, and the space 5 also has a rectangular parallelepiped shape (quadrangular prism shape). Since all of the wall members 41, the upper member 42, and the lower member 43 can be manufactured by only linear cutting, such members can be manufactured easily, reducing the manufacturing cost.

According to the present disclosure, it is possible to provide an ink cartridge having an absorber that absorbs ink and a space for storing the ink in a container, in which leakage of the ink from an atmosphere opening port is suppressed even when the posture is changed or an impact is applied.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-121287, filed on Jul. 26, 2024, which is hereby incorporated by reference herein in its entirety.

What is claimed is:

1. An ink cartridge comprising:
an absorber that is capable of absorbing ink; and
a container that contains therein the absorber and the ink, the container being provided with an opening port that opens an interior of the container to an atmosphere,
wherein the absorber is provided with a space capable of storing the ink, and
wherein the space does not contact a bottom surface inside the container in a state in which the absorber is contained in the container.

2. The ink cartridge according to claim 1, wherein the space does not contact a side surface inside the container in a state in which the absorber is contained in the container.

3. The ink cartridge according to claim 1, further comprising a head provided at a bottom portion of the container, the head being capable of being supplied with the ink contained in the container and ejecting the ink,
wherein an area in which the head is provided does not overlap an area in which the space is provided, in a case of being viewed in a direction perpendicular to the bottom portion.

4. The ink cartridge according to claim 1, wherein the space has a cylindrical shape.

5. The ink cartridge according to claim 1, wherein the space has a rectangular parallelepiped shape.

6. The ink cartridge according to claim 1, wherein the space is provided so as to penetrate the absorber in a first direction along the bottom surface inside the container.

7. The ink cartridge according to claim 1,
wherein the absorber includes a body portion provided with the space so as to penetrate the body portion in a first direction along the bottom surface inside the container, and side surface portions located at both end portions of the body portion in the first direction, and
wherein the space is closed by the side surface portions so as to be a closed space in a state in which the absorber is contained in the container.

8. The ink cartridge according to claim 7, wherein the body portion and the side surface portions have the same cross-sectional shape perpendicular to the first direction.

9. The ink cartridge according to claim 7,
wherein the space provided in the body portion and the side surface portions have the same cross-sectional shape perpendicular to the first direction, and
wherein the side surface portions are integrated with the body portion by being inserted into the space.

10. The ink cartridge according to claim 1, wherein the absorber is constituted by combining a plurality of rectangular parallelepiped members extending in a first direction along the bottom surface inside the container.

11. An ink ejection apparatus comprising:
an absorber that is capable of absorbing ink;
a container that contains therein the absorber and the ink, the container being provided with an opening port that opens an interior of the container to an atmosphere; and
a head provided at a bottom portion of the container, the head being capable of being supplied with the ink contained in the container and ejecting the ink, the ink being ejected from the head to a recording medium,
wherein the absorber is provided with a space capable of storing the ink, and
wherein the space does not contact a bottom surface inside the container in a state in which the absorber is contained in the container.
